(19) United States
(12) Patent Application Publication
(10) Pub. No.: US 2009/0279152 A1
(43) Pub. Date: Nov. 12, 2009

(54) HOLOGRAM RECORDER

(75) Inventors: Yuzuru Yamakage, Kawasaki (JP); Kazushi Uno, Kawasaki (JP); Hiroyasu Yoshikawa, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/506,906

(22) Filed: Jul. 21, 2009

Related U.S. Application Data
(63) Continuation of application No. PCT/JP2007/055209, filed on Mar. 15, 2007.

(51) Int. Cl. G03H 1/26

(52) U.S. Cl. 359/22; 359/30

(57) ABSTRACT

A hologram recording apparatus includes an objective lens (7) for illuminating a hologram recording medium (B) with a recording beam (S) in a manner such that the recording beam overlaps a reference beam, thereby performing multiple recording of holograms at a portion illuminated with the reference beam and the recording beam (S). The objective lens (7) includes at least one rotationally symmetric lens (7A, 7B), and at least one rotationally symmetric lens (7A) is so arranged that the lens optical axis is inclined with respect to the direction (S1) in which the recording beam (S) travels.

### TECHNICAL FIELD

This application is a Continuation based on International Application No. PCT/JP2007/055209.

The present invention relates to a hologram recording apparatus including an objective lens for illuminating a hologram recording medium with a recording beam.

### BACKGROUND ART

An example of conventional hologram recording apparatus is disclosed in Patent Document 1. The hologram recording apparatus disclosed in this document includes an objective lens for illuminating a hologram recording medium with a recording beam and a reference beam by so-called collinear holography. The focusing performance of an objective lens can be enhanced by increasing the numerical aperture (NA). However, when the focusing performance is enhanced, the recording material of a recording layer is consumed locally at the portion onto which the light is focused. This leads to optical deterioration of reproduction signals and is disadvantageous for the enhancement of multiplicity in multiple recording. Conventionally, to avoid the drawbacks, the hologram recording medium is so set that the recording layer is located at a position deviated from the focal point by so-called defocusing. In this state, a recording beam and a reference beam are directed to the hologram recording medium.

Patent Document 1: Japanese Lain-open Patent Publication No. 2006-113296

However, in the conventional hologram recording apparatus, the illumination area of the recording beam and the reference beam increases in the recording layer due to the defocusing. Thus, the so-called book size increases in multiple recording, which is not suitable for increasing the recording density.

### DISCLOSURE OF THE INVENTION

The present invention has been proposed under the circumstances described above. It is, therefore, an object of the present invention to provide a hologram recording apparatus which is capable of enhancing the multiplicity of the multiple recording while also increasing the recording density.

To solve the problem described above, the present invention takes the following technical measures.

According to a first aspect of the present invention, there is provided a hologram recording apparatus comprising an objective lens for illuminating a hologram recording medium with a recording beam in such a manner as to overlap a reference beam. The hologram recording apparatus is designed to perform multiple recording of holograms at a portion illuminated with the reference beam and the recording beam. The objective lens includes at least one rotationally symmetric lens, and at least one rotationally symmetric lens is so arranged that the lens optical axis is inclined with respect to the direction in which the recording beam travels.

Preferably, as the rotationally symmetrical lens, a first lens and a second lens are provided on the light incident side and the light emitting side with respect to the recording beam, respectively. The lens optical axis of the first lens is inclined with respect to the direction in which the recording beam travels.

Preferably, the first lens comprises a biconvex lens, whereas the second lens comprises a concavo-convex lens, the concave surface of which serves as the light emitting surface.

According to a second aspect of the present invention, there is provided a hologram recording apparatus comprising an objective lens for illuminating a hologram recording medium with a recording beam in such a manner as to overlap a reference beam. The hologram recording apparatus is designed to perform multiple recording of holograms at a portion illuminated with the reference beam and the recording beam. The objective lens comprises a combination of a plurality of rotationally symmetric lenses, and at least one of the rotationally symmetric lenses is so arranged that the lens axis is deviated from a travel direction center axis of the recording beam while extending in parallel to the center axis.

Preferably, the rotationally symmetrical lenses include a first lens and a second lens provided on the light incident side and the light emitting side with respect to the recording beam, respectively. The first lens is so arranged that the lens axis is deviated from the travel direction center axis of the recording beam while extending in parallel to the center axis.

Preferably, the first lens comprises a biconvex lens, whereas the second lens comprises a concavo-convex lens, the concave surface of which serves as the light emitting surface.

### BRIEF DESCRIPTION OF THE DRAWINGS

FIG. 1 is an overall structural view illustrating a hologram recording apparatus according to a first embodiment of the present invention.

FIG. 2 illustrates the light path of the objective lens provided in the hologram recording apparatus of FIG. 1.

FIG. 3 illustrates comparative examples relative to the present invention.

FIG. 4 illustrates the light path of a hologram recording apparatus according to another embodiment of the present invention.

FIG. 5 illustrates comparative examples relative to the present invention.

### BEST MODE FOR CARRYING OUT THE INVENTION

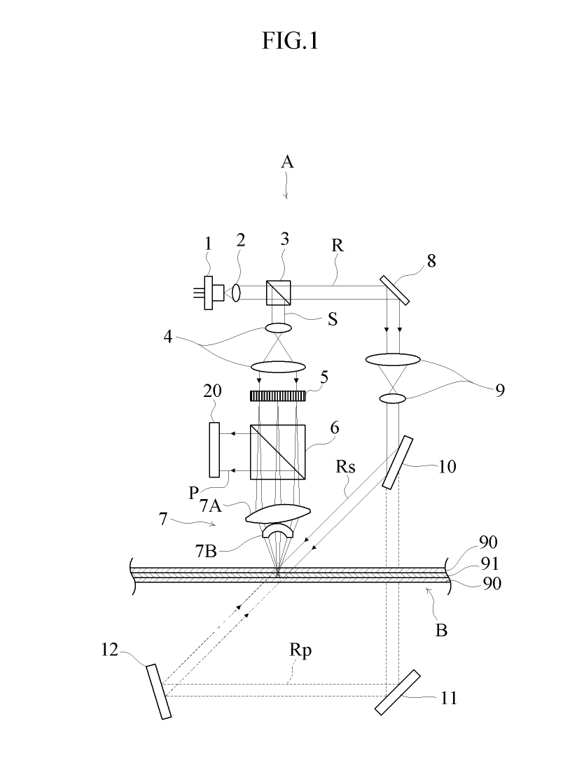

Preferred embodiments of the present invention will be described below with reference to the accompanying drawings. FIGS. 1-3 illustrate a hologram recording apparatus according to a first embodiment of the present invention.

As illustrated in FIG. 1, the hologram recording apparatus A is designed to record holograms by illuminating a hologram recording medium B with a recording beam S in such a manner as to overlap a recording reference beam Rs. In the reproducing process, a reproducing reference beam Rp as phase conjugate light for the recording reference beam Rs is directed to the hologram recording medium B. The holograms are reproduced by receiving the reproduction beam P produced by diffraction.

The hologram recording apparatus A includes a light source 1, a collimating lens 2, a beam splitter 3, a recording zoom lens 4, a spatial light modulator 5, a half mirror 6, an objective lens 7 to which the present invention is applied, a first reflector 8, a reference zoom lens 9, a recording galvano mirror 10, a second reflector 11, a reproducing galvano mirror 12 and a reproducing imaging element 20. The hologram recording medium B used for the hologram recording apparatus A includes a recording layer 91 arranged between two light-transmitting protective layers 90. The recording layer 91 is illuminated with light from the opposite sides. The recording layer 91 is about 1.5 mm in thickness. Holograms are recorded on the recording layer 91 by the interference between the recording beam S and the recording reference beam Rs. In the reproducing process, as indicated by the broken lines, the reproducing reference beam Rp is directed to the recording layer 91 from the side of the recording layer opposite the recording process. By the interference of the reproducing reference beam Rp with the hologram, diffraction light is produced, which travels toward the objective lens 7 as the reproduction beam P.

The light source 1 is provided by e.g. a semiconductor laser device and emits a laser beam having a relatively narrow band and a high coherency. The collimating lens 2 converts the laser beam emitted from the light source 1 into a parallel beam. The parallel beam emitted from the collimating lens 2 is split by the beam splitter 3 into a recording beam S and a reference beam R. The recording beam S enters the spatial light modulator 5 after the beam diameter is increased by the recording zoom lens 4. In the recording process, the reference beam R travels successively through the first reflector 8, the reference zoom lens 9 and the recording galvano mirror 10 to illuminate the hologram recording medium B as the recording reference beam Rs. In the reproducing process, the reference beam R travels successively through the first reflector 8, the reference zoom lens 9, the second reflector 11 and the reproducing galvano mirror 12 to illuminate the hologram recording medium B as the reproducing reference beam Rp. The recording reference beam Rs and the reproducing reference beam Rp are phase conjugate to each other, and the respective angles of incidence on the hologram recording medium B can be changed by the corresponding galvano mirrors 10 and 12. Thus, a plurality of holograms corresponding to the angle of incidence of the recording reference beam Rs are recorded on the recording layer 91 as multiple recording. In the reproducing process, the plurality of holograms are read from the recording layer 91 correspondingly to the angle of incidence of the reproducing reference beam Rp.

The spatial light modulator 5 is provided by e.g. a liquid crystal device of a transmission type. In the spatial light modulator 5, the recording beam S is modulated into the light of a pixel pattern corresponding to the information to be recorded. The recording beam S exiting the spatial light modulator 5 travels through the objective lens 7 to illuminate the hologram recording medium B in such a manner as to interfere with the recording reference beam Rs at the recording layer 91. In the reproducing process, the reproduction beam P is produced by the interference between the holograms recorded on the recording layer 91 and the reproducing reference beam Rp. The reproduction beam P travels through the objective lens 7 in the direction opposite the recording beam S and is reflected by the half mirror 6 to be received by the reproducing imaging element 20. In this way, the holograms recorded on the recording layer 91 are read.

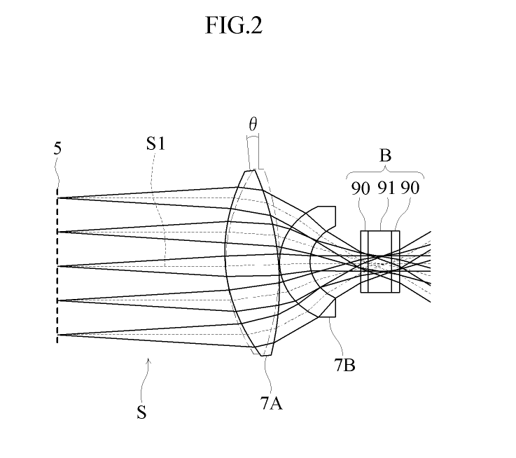

As illustrated in FIG. 2, the objective lens 7 includes a first lens 7A and a second lens 7B, which are arranged on the light incident side and the light emitting side with respect to the recording beam S, respectively. The first lens 7A is provided by a rotationally symmetric biconvex lens. The second lens 7B is provided by a rotationally symmetric concavo-convex lens, the concave surface of which serves as the light emitting surface. The second lens 7B is so arranged that the lens optical axis aligns with the travel direction center axis S1 of the recording beam S. The first lens 7a is so arranged that the lens optical axis is inclined with respect to the travel direction center axis S1. The angle of inclination θ is e.g. about 7.5 degrees. In this objective lens 7, the recording beam S exiting the spatial light modulator 5 first enters the first lens 7A as a parallel beam. Since the first lens 7A is inclined, the recording beam S exiting the first lens 7A and traveling through the second lens 7B impinges on the recording layer 91, with different bundles of light focusing on slightly different points. That is, the objective lens 7 has large aberration with respect to the hologram recording medium B, and hence, does not provide a high focusing performance.

The recording beam S after passing through the objective lens 7 interferes with the recording reference beam Rs at the recording layer 91. In this process, the angle of incidence of the recording reference beam Rs is changed by the operation of the galvano mirror 10. Thus, optically different holograms corresponding to the angle of incidence of the recording reference beam Rs are recorded on the recording layer 91 as multiple recording. In reproducing the holograms, the galvano mirror 11 is operated to form the same angle of incidence as that in the recording process, and the reproducing reference beam Rp is directed to the hologram recording medium B from the reverse side of the hologram recording medium. At the recording layer 91, the reproducing reference beam Rp interferes with the recorded holograms to produce diffraction light. The diffraction light travels through the objective lens 7 and the half mirror 6 to be received by the imaging element 20. Thus, the holograms of multiple recording are reproduced every time the angle of incidence of the reproducing reference beam Rp is changed. In this process, the reproduction beam P passes through the objective lens 7 having an aberration. Since the objective lens 7 also allows the recording beam S to pass through in the recording process, the reproduction beam P passes through the same light path as the recording beam S and is then guided to the imaging element 20. Thus, the recording beam S and the reproduction beam P passing through the same objective lens 7 have the same or similar optical distortion, so that the reproduction beam P having the same pattern as that in the recording process is obtained reliably.

The characteristics and advantages of the objective lens 7 will be described below.

As illustrated in FIG. 2, with the objective lens 7 of this embodiment, the focusing performance is low because of the large aberration. Thus, the light intensity does not become locally high in the recording layer 91 at the portion which the recording beam S and the recording reference beam Rs illuminate in an overlapping manner. Thus, the recording material is not locally consumed at the portion illuminated with the recording beam S and the recording reference beam Rs even by multiple recording. This means that the optical characteristics of reproduction signals are not deteriorated and the number of multiple recording is enhanced.

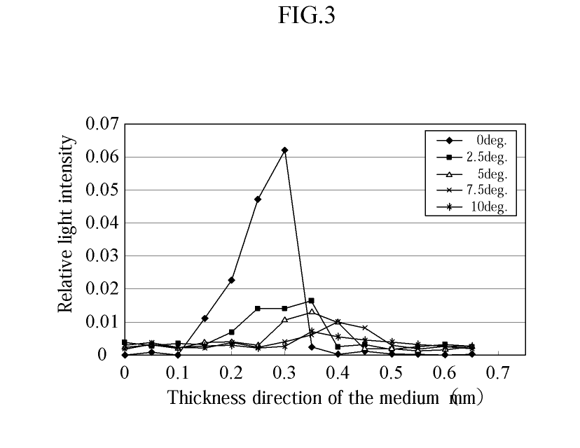

FIG. 3 demonstrates comparative examples. When use is made of an objective lens including a first lens whose angle of inclination θ is 0 degree, the relative light intensity is considerably high in the recording layer 91 of the hologram recording medium B at or near a portion of 0.3 mm in the thickness direction. In this comparative example, the locally high light intensity deteriorates the optical characteristics. In contrast, the objective lens 7 including a first lens 7A whose angle of inclination θ is 7.5 degrees, which is the structure of this embodiment, provides uniform relative light intensity throughout the thickness of the recording layer 91. From the comparative examples, it will be understood that the aberration of the objective lens 7 increases as the angle of inclination θ of the first lens increases, and a larger aberration makes the light intensity more uniform and more reliably prevents the local consumption of the recording material.

Even when the aberration of the objective lens 7 increases, the recording beam S does not spread largely on the recording layer 91 in the plane direction. Thus, the size of the illumination portion, which is the unit recording area of multiple recording, does not increase significantly and is kept substantially equal to the size in the conventional structure.

Thus, according to the hologram recording apparatus A including the objective lens 7 of this embodiment, the inclination of the first lens 7A provides aberration of the objective lens 7. Due to the aberration of the lens, local increase of the light intensity is prevented. This ensures an increase in multiplicity in recording a plurality of holograms at a same illumination portion in an optically overlapping manner. The size of the illumination portion is kept substantially equal to that in the conventional structure. Thus, as the multiplicity of the multiple recording increases, the recording density of holograms increases.

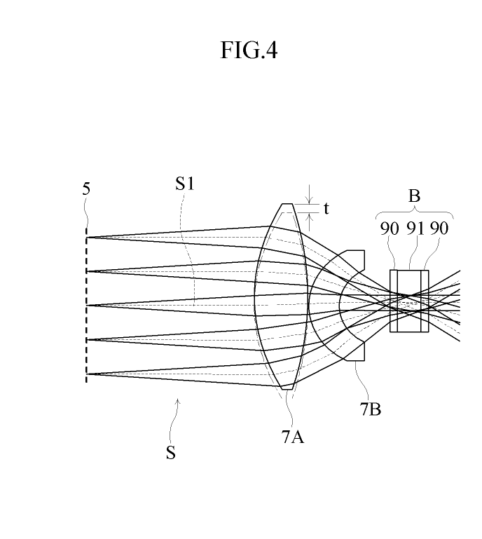

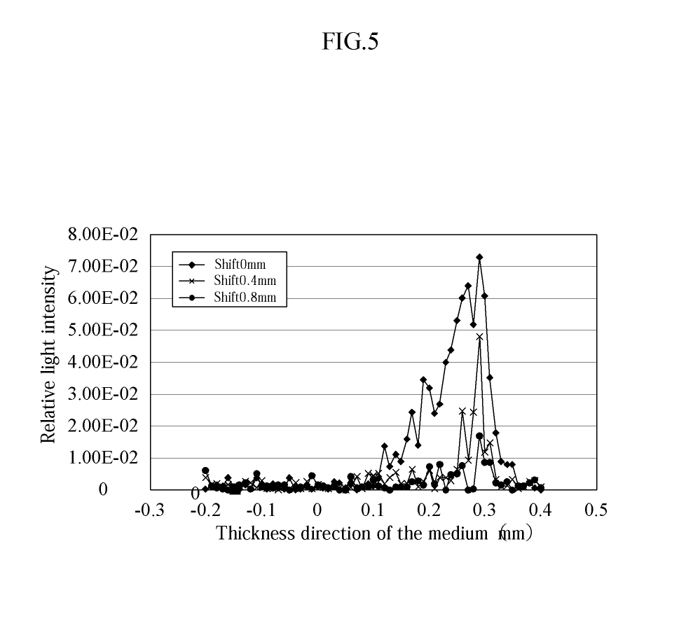

FIGS. 4 and 5 illustrate a hologram recording apparatus according to another embodiment of the present invention. In these figures, the elements which are identical or similar to those of the foregoing embodiment are designated by the same reference signs as those used for the foregoing embodiment, and the description is omitted.

The objective lens 7 illustrated in FIG. 4 also includes a first lens 7A and a second lens 7B having optical characteristics similar to those of the foregoing embodiment. The second lens 7B is so arranged that the lens optical axis aligns with the travel direction center axis S1 of the recording beam S. The first lens 7A of this embodiment is so arranged that the lens optical axis is deviated from the travel direction center axis S1 while extending in parallel to the center axis. The amount of deviation (amount of shifting) t is e.g. about 0.8 mm. With this arrangement of the objective lens 7 again, the recording beam S exiting the first lens 7A and traveling through the second lens 7B impinges on the recording layer 91, with different bundles of light focusing on slightly different points. Thus, the objective lens 7 has large aberration with respect to the hologram recording medium B, and hence, does not provide a high focusing performance.

FIG. 5 demonstrates comparative examples. When use is made of an objective lens including a first lens whose amount of shifting is 0 mm, the relative light intensity is considerably high in the recording layer 91 of the hologram recording medium B at or near a portion of 0.3 mm in the thickness direction. In this comparative example, the locally high light intensity deteriorates the optical characteristics. In contrast, the objective lens 7 including a first lens 7A whose amount of shifting is 0.8 mm, which is the structure of this embodiment, provides uniform relative light intensity throughout the thickness of the recording layer 91. From the comparative examples, it will be understood that the aberration of the objective lens 7 increases as the amount of shifting of the first lens increases, and a larger aberration makes the light intensity more uniform and more reliably prevents the local consumption of the recording material.

Thus, the objective lens 7 including a first lens 7A which is translated also provides aberration and hence, increases the multiplicity of holograms, which contributes to an increase in the recording density of holograms.

The present invention is not limited to the foregoing embodiments.

The structures of the foregoing embodiments are merely examples and may be appropriately varied in design in accordance with the specifications.

For example, the number of lenses for constituting the objective lens is not limited to two but may be three or more. The second lens may be inclined or deviated instead of the first lens. Alternatively, both of the first and the second lenses may be inclined or deviated.

1. A hologram recording apparatus comprising an objective lens for illuminating a hologram recording medium with a recording beam in such a manner as to overlap a reference beam, the hologram recording apparatus being designed to perform multiple recording of holograms at a portion illuminated with the reference beam and the recording beam;
wherein the objective lens includes at least one rotationally symmetric lens, and at least one rotationally symmetric lens is so arranged that a lens optical axis thereof is inclined with respect to a direction in which the recording beam travels.

2. The hologram recording apparatus according to claim 1, wherein, as the rotationally symmetrical lens, a first lens and a second lens are provided on a light incident side and a light emitting side with respect to the recording beam, respectively, and a lens optical axis of the first lens is inclined with respect to the direction in which the recording beam travels.

3. The hologram recording apparatus according to claim 2, wherein the first lens comprises a biconvex lens, whereas the second lens comprises a concavo-convex lens, the concave surface of which serves as a light emitting surface.

4. A hologram recording apparatus comprising an objective lens for illuminating a hologram recording medium with a recording beam in such a manner as to overlap a reference beam, the hologram recording apparatus being designed to perform multiple recording of holograms at a portion illuminated with the reference beam and the recording beam;
wherein the objective lens comprises a combination of a plurality of rotationally symmetric lenses, and at least one of the rotationally symmetric lenses is so arranged that a lens axis thereof is deviated from a travel direction center axis of the recording beam while extending in parallel to the center axis.

5. The hologram recording apparatus according to claim 4, wherein the rotationally symmetrical lenses include a first lens and a second lens provided on a light incident side and a light emitting side with respect to the recording beam, respectively, and the first lens is so arranged that a lens axis thereof is deviated from the travel direction center axis of the recording beam while extending in parallel to the center axis.

6. The hologram recording apparatus according to claim 5, wherein the first lens comprises a biconvex lens, whereas the second lens comprises a concavo-convex lens, the concave surface of which serves as a light emitting surface.
